(19) United States
(12) Patent Application Publication
(10) Pub. No.: US 2009/0019379 A1
(43) Pub. Date: Jan. 15, 2009

(54) Document Redaction in a Web-Based Data Analysis and Document Review System

(76) Inventors: Brian S. Pendergast, East Greenwich, RI (US); Nicholas C. Croce, Old Brookville, NY (US); Richard Rupp, Plandome Manor, NY (US)

Correspondence Address: FISH & RICHARDSON P.C., P.O. BOX 1022, MINNEAPOLIS, MN, 55440-1022, US

(21) Appl. No.: 12/109,065

(22) Filed: Apr. 24, 2008

Related U.S. Application Data
(60) Provisional application No. 60/959,575, filed on Jul. 12, 2007.

(51) Int. Cl. G06F 3/00

(52) U.S. Cl. 715/762

(57) ABSTRACT

A web-based data analysis and document review system is operable to provide a graphical user interface that allows a user to make and save redactions within a selected document set, apply the redactions to other document sets, clear redactions on a particular page of a document, and clear all redactions within the document.

### CLAIM OF PRIORITY

This application claims priority under 35 USC §119(e) to U.S. Provisional Patent Application Ser. No. 60/959,757, filed on Jul. 12, 2007, the entire contents of which are hereby incorporated by reference.

### TECHNICAL FIELD

This disclosure relates to document redaction in a web-based data analysis and document review system.

### BACKGROUND

With the ever-increasing amount of electronic data held by individuals and corporations, the access and analysis of that data has increased the time and budget associated, for example, with litigation and compliance (e.g., Sarbanes-Oxley). These burdens are compounded by the recently amended U.S. Federal Rules of Civil Procedure that mandate production of Electronically Stored Information (“ESI”) and early “meet and confers” to discuss ESI. The legal and business community is therefore faced with additional pressure to manage risk and strategically manage their ESI.

To manage ESI, many have turned to electronic data mining, document review, and document management applications. These applications usually involve (1) a server that houses the ESI for review and access and (2) user terminals that are adapted to review, edit and search the ESI. The server and user terminals interface with each other via a network such as the Internet, an intranet, a LAN and/or WAN. The server usually is coupled to a large data store because the amount of electronic data reviewed/produced in a litigation or generated by a corporation in its ordinary course can easily reach the terabyte (“TB”) range. Often, in order to protect confidential or privileged information, it is desirable or necessary to redact portions of documents prior to producing the documents to a third party.

### SUMMARY

Various aspects of the invention are recited in the claims.

For example, in one aspect, a web-based data analysis and document review system is operable to provide a graphical user interface that allows a user to make and save redactions within a selected document set, apply the redactions to other document sets, clear redactions on a particular page of a document, and clear all redactions within the document.

In some implementations, redactions can be made to multiple document sets substantially simultaneously. A dialog box can be displayed to allow the user to select the document sets to which the redactions are to be applied, and multiple different redacted versions of a document can be saved to different document sets.

In some implementations, when a cursor is placed over a redacted area of a document appearing, for example, on a user terminal, the system displays an information box that indicates the identification of a person who added the redaction to the document, and at least one of the date and time of the redaction. A label can be displayed over the redacted area of a document, wherein contents of the label are based on information entered through the graphical user interface.

In some implementations, a dialog box can be displayed to list a history of a selected redaction.

Redaction capabilities can be provided on a per-user basis, wherein different users or classes of users are given different redaction capabilities.

Other aspects, features and various advantages will be readily apparent from the following detailed description, the accompanying drawings, and the claims.

### BRIEF DESCRIPTION OF THE DRAWINGS

FIG. 1 is an example of a screenshot for a web-based data analysis and review system.

FIG. 2 is an example of a screenshot illustrating results of a search query.

FIG. 2A is an enlarged version of part of FIG. 2.

FIG. 3 is an example of screenshot with redaction mode capability.

FIG. 4 is an example of a screenshot that includes a link for adding redactions.

FIG. 5 is an example of a screenshot showing a document with solid redactions.

FIG. 6 is an example of a screenshot showing a document with transparent redactions.

FIG. 7 is an example of a screenshot showing additional document redaction features.

FIG. 8 illustrates an example of a dialog box for managing redaction sets.

FIG. 9 illustrates an example of a pointer for resizing a redacted area of a document.

FIG. 10 illustrates an example of a redaction information hover.

FIG. 11 illustrates an example of a context menu.

FIG. 12 is an example of a dialog box for listing the redaction history of a document.

FIG. 13 is an example of a dialog box for editing labels for a redacted document.

FIG. 14 illustrates an example of the architecture for the web-based data analysis and document review system.

FIGS. 15A, 15B and 15C illustrate additional details of a redaction service.

FIG. 16 is a list of multi-part document controls.

FIG. 17 is a list of examples of fields stored in a database associated with the redaction service.

### DETAILED DESCRIPTION

As explained in greater detail below, a web-based data analysis and document review system provides scalability and advanced concept analytics to allow users to identify key document sets and concepts quickly. Datasets can be analyzed to determine the potential merits of a case and can help identify the impact of specific keywords and concepts, enabling better preparation for meet and confer, or other, negotiations.

For investigations, the web-based platform provides a powerful analytics solution that enables rapid identification of key documents in very large data stores. A combination of Boolean keyword searching and Bayesian concept analytics allows users to drill down through the dataset, revealing key documents and communications in a few keystrokes.

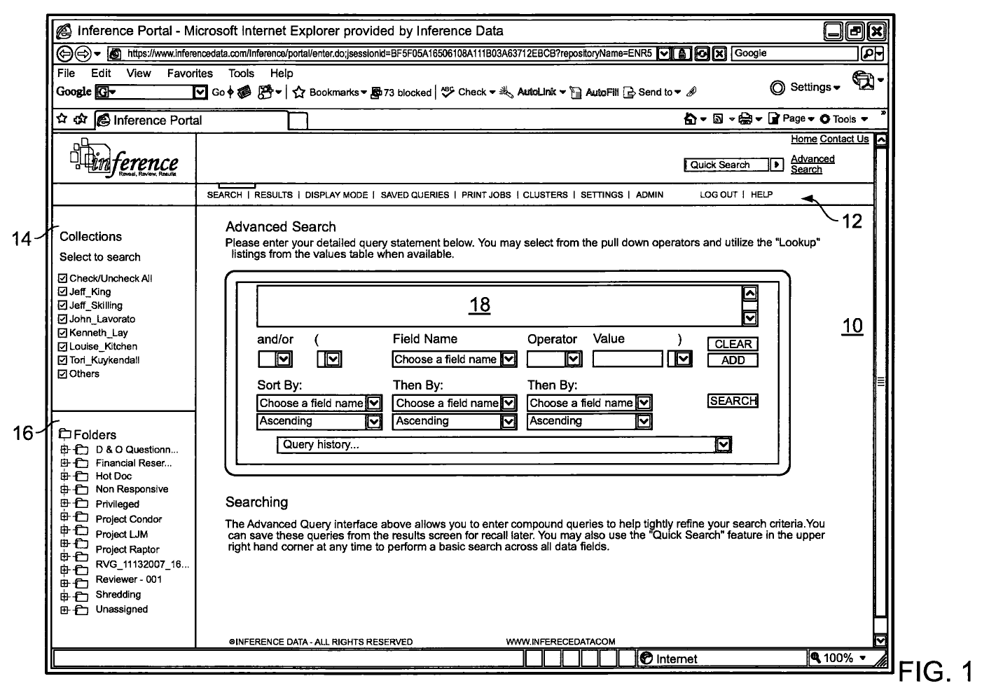

FIG. 1 illustrates an example of the main screen 10 of the web-based platform. The screen 10 provides a graphical user interface and includes a configurable function bar 12 for quick navigation. Among the tabs that can be selected from the function bar 12 are a “Search” tab, a “Results” tab, a “Display Mode” tab, a Saved Queries” tab, a “Print Jobs” tab, a “Clusters” tab, a “Settings” tab and an “Administration” tab.

The screen 10 also lists collections of custodian or data sets 14 and dynamic folders 16 to organize data for the review process. Any of the collections 14 or folders 16 can be selected by a user.

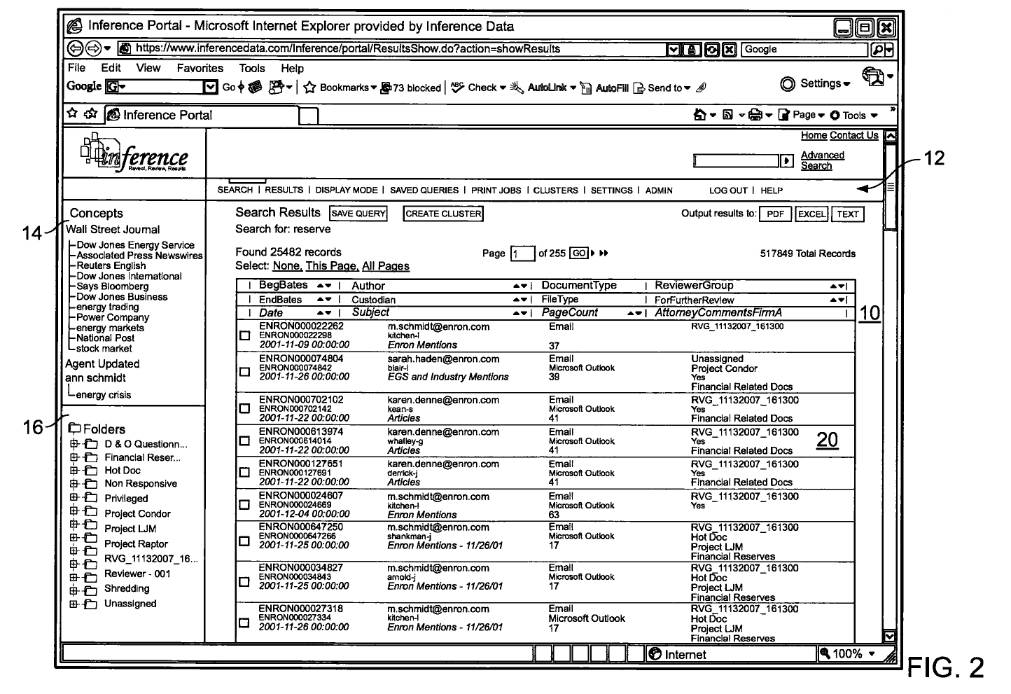

The screen 10 further provides an advanced search pane 18 to drive sophisticated Boolean searching of the selected documents. Upon entry of search query, the system searches across the selected data set and returns documents related to the user's search. The system highlights dynamic concepts found within the search and allows the user to drill deeper into the concept data set. FIG. 2 illustrates an example of a search results screen 20.

The system enables more efficient and faster review by prioritizing mid and large size document collections into potentially responsive and non-responsive folders. By clustering and then grouping documents into similar concepts across the whole database, folders can be created and assigned to the appropriate level reviewer to aide in workflow management.

An image of particular document can be viewed, for example, by using an electronic mouse to move a cursor on the screen and then clicking on the desired document. The selected documents appears on the screen so that it can be reviewed.

Linear review functions include a redaction mode that allows users to mark selected areas of a document for privilege in both solid and transparent formats. The redaction features enable a user to hide selected areas of a document for various production sets, and to use labels describing each redaction. Thus, the redacted or hidden area(s) can contain a text label indicating, for example, the reason for the redaction. Moreover, the labels can be customized during the redaction process.

Redacted documents are added to one or more document sets, each of which is associated with a document production. This allows different areas of a document to be redacted for different productions. Additional fields can facilitate tracking for the purpose of privilege logs and the like. The redaction feature can be turned on or off selectively for each available document repository. Furthermore, access to the redaction feature can be made available on a per-user basis.

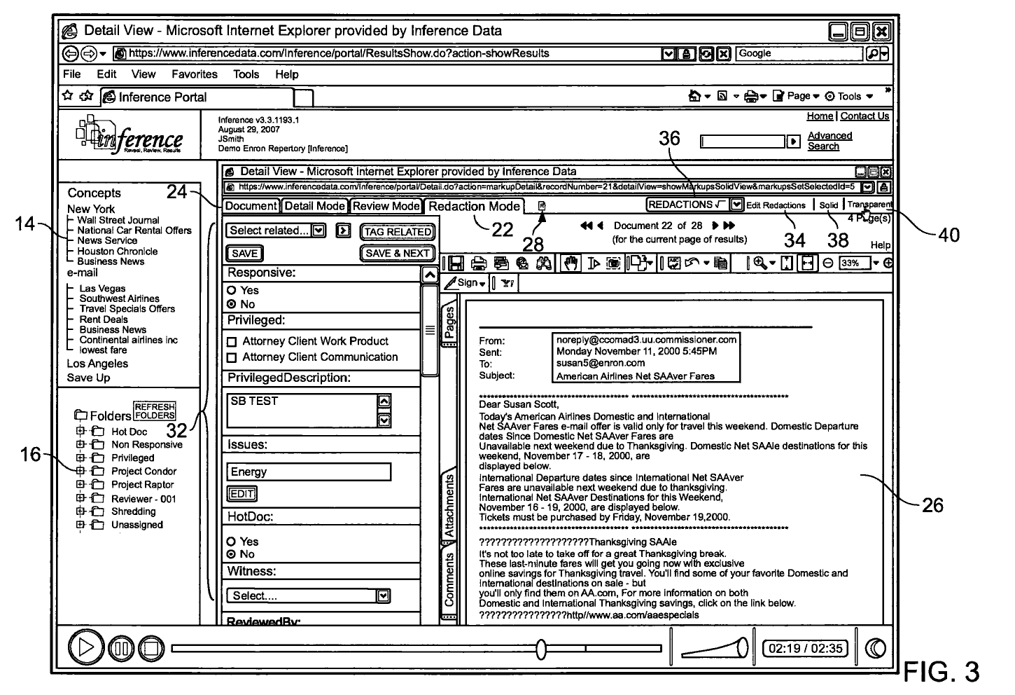

To enter the redaction mode when a document is displayed, the user selects the “Redaction Mode” tab 22 from a tab bar 24 (FIG. 3). The document is displayed in a document window 26. A review panel 32 appears adjacent the document window 26 and provides various metadata fields that facilitate a reviewer's making notations about the status of the document. Examples of such notations include indications of whether the document is responsive to a discovery request, whether the document contains information that is subject to the attorney-client privilege, and whether the document contains attorney work product.

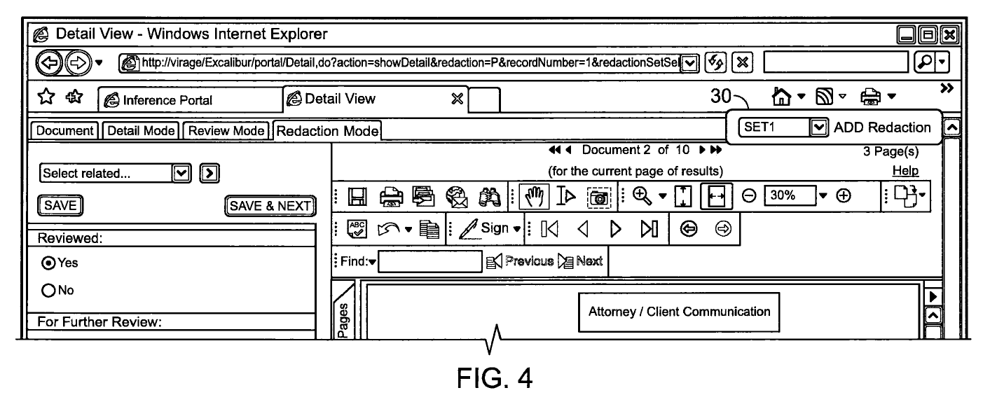

If the displayed document was not previously redacted, then an “ADD Redaction” hyperlink 30 is displayed (see FIG. 4). Clicking the link 30 allows the user to add redactions for the previously unredacted document.

If the displayed document already contains redacted areas, a special redaction icon 28 (e.g., a capitalized red ‘R’) appears in the tab bar 24. Furthermore, the color of the text can be used to provide a visual cue that the document is displayed in the redaction mode. For example, in a particular implementation, red text is used to indicate the redaction mode.

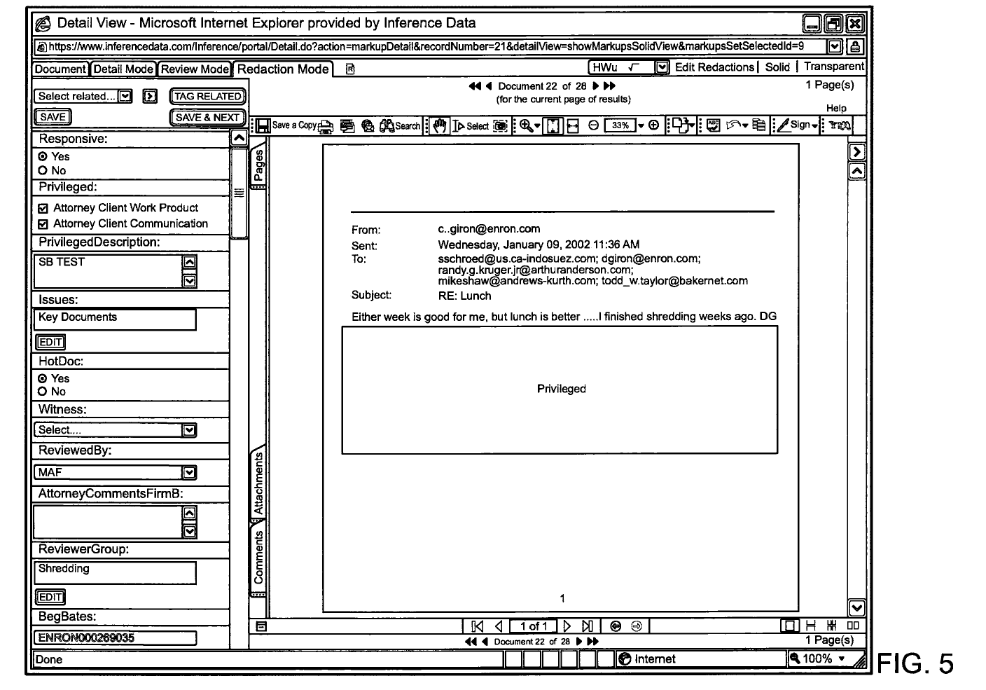

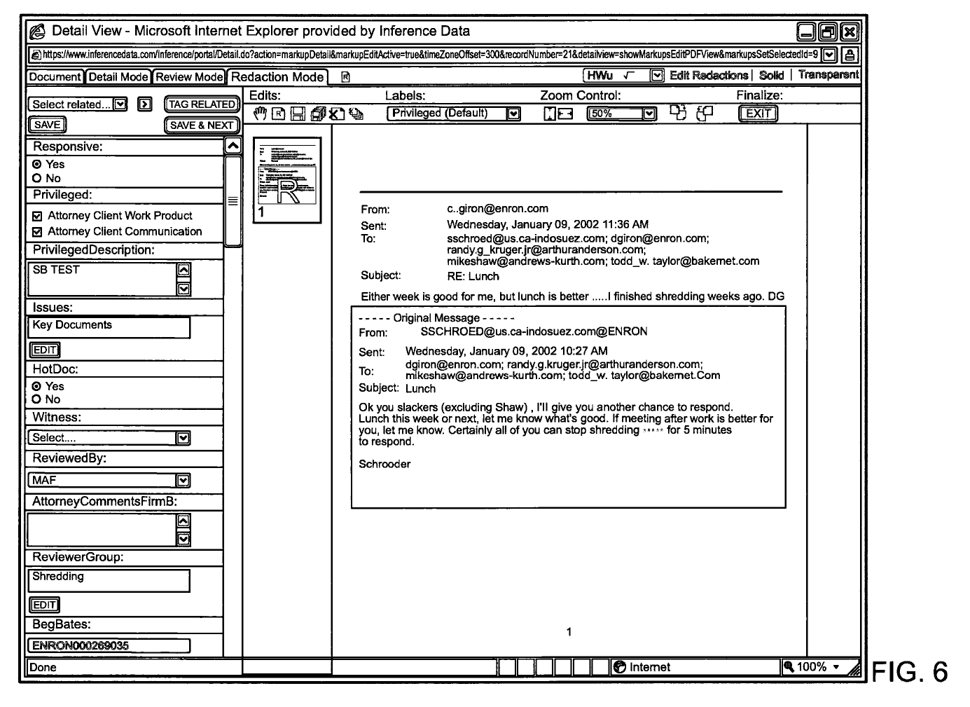

Furthermore, if the document already contains redactions, then an “Edit Redactions” link 34 is displayed (see FIG. 3). To add new redactions or edit existing redactions, the user selects the “Edit Redactions” hyperlink 34. The user has the ability to choose how the redactions are displayed by selecting one of two hyperlinks. Clicking the “Solid” link 38 displays an opaque version of the redacted areas (see FIG. 5), whereas clicking the “Transparent” link 40 displays the document with the redacted text visible to allow the user to see the redacted text. In the latter case, a transparent or partially transparent box is displayed over the redacted text (see FIG. 6).

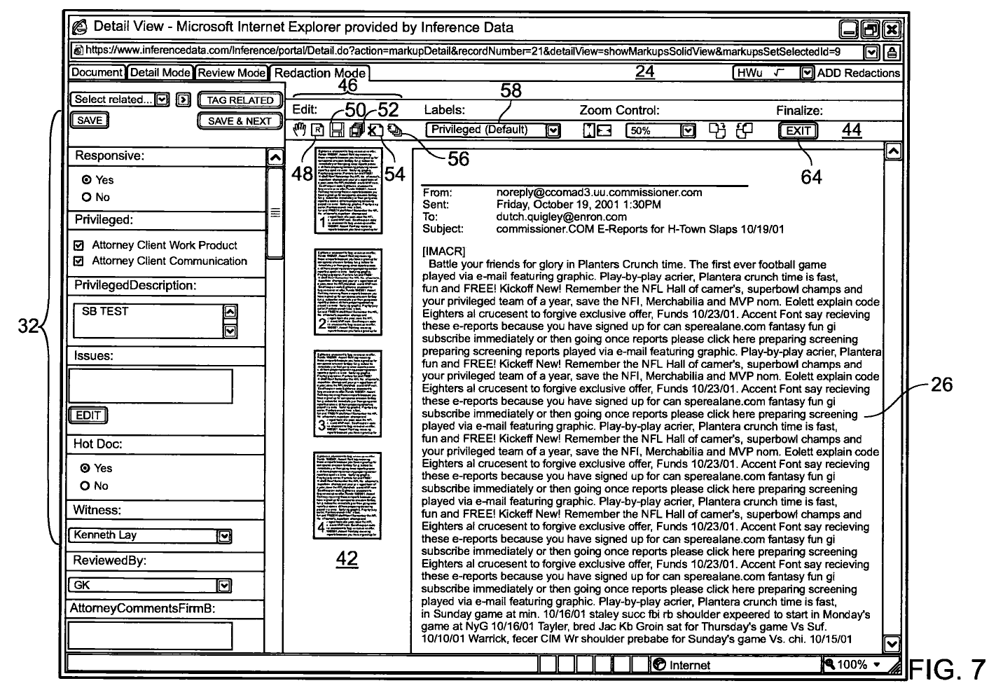

When the “Edit Redactions” link 34 is selected, thumbnail versions of each page of the document appear in the center panel 42 with a larger page view in the document window 26 (FIG. 7). If any page within the document contains a saved redaction, the thumbnail version of that page will be displayed with visual indicator (e.g., a red ‘R’ over the thumbnail version of the page). The left-hand window displays the same meta-data as displayed in review panel 32 of FIG. 3. As illustrated in FIG. 7, when the “Edit Redactions” link 34 is selected, the system displays a new toolbar 44 with a redaction edit menu 46 which allows the user to save redactions within a selected document set, apply the redactions to other sets, clear redactions on a particular page of the document or clear all redactions within the document.

For example, using the redaction edit menu 46, a user can add redactions by selecting the “add redactions” button 48. Changes to a page of a document can be saved by selecting the “save” button 50 or selecting another page within the document. Selection of another page within the document automatically saves any changes to the redactions. Redactions can be made to multiple document sets simultaneously by using the “save as” button 52, which causes the system to display a dialog box to allow the user to select the set(s) to which the current redactions are to be applied.

Redactions to a particular page can be cleared by selecting the page and then clicking on the “clear page” button 54. In response, the system displays a dialog box asking the user to confirm the indicated action. Likewise, redactions to an entire document can be cleared by selecting the “clear all pages” button 56. In response, the system displays a dialog box asking the user to confirm the indicated action. If all redactions are removed from a document, a database field associated with the document is updated to indicate that the document has no redactions. Also, if the user selects the “clear page” button 54 when the displayed page is the only page of the document that had redactions, then the document is logged in a database as an “orphan” document when the user clicks the “Exit” button 64.

A document can be saved in multiple different redacted versions for those situations in which it needs to be produced, for example, to different parties within multiple matters. The system can store multiple redaction sets, each of which represents a set of documents to be produced to a different party or for a different purpose. A drop-down menu 36 is displayed on the user screen and enables the user to select one or more sets with which the redacted version of the document is to be associated at the time of production. This streamlines the review process by allowing different redactions to be applied and saved to one or more sets at one time. A check mark appears next to each set containing the redacted document to provide a visual indicator to the user. As described above, if the user wishes to edit redactions or add redactions for a particular set only, the user selects the set of interest from the drop-down menu 36 and makes the desired modifications on the face of the particular document.

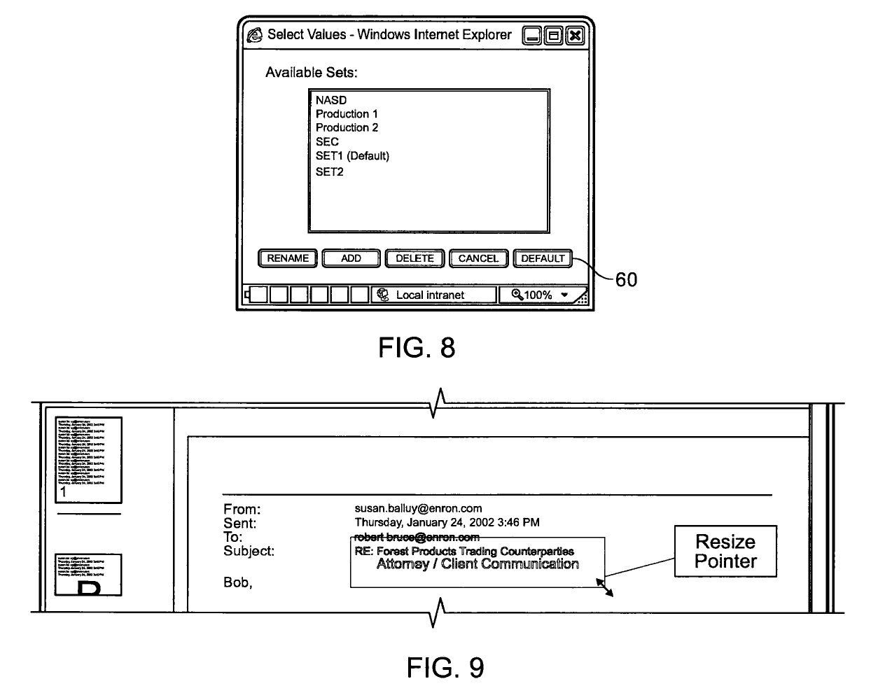

If the user wishes to create a new set of documents and add redactions for the document being reviewed, the user clicks on an “Edit Sets” option from the drop-down menu 36. The system then displays a dialog box (FIG. 8) which lists the available redaction sets created in the repository. The dialog box allows the user to rename an existing redaction set, as well as add or delete existing sets. Clicking a “Default” button 60 makes the selected set the default choice for all new redactions.

After the user selects a redaction set from the drop-down menu 36, the user can redact a selected area of the displayed document by placing the cursor over one corner of the area to be redacted, and dragging the cursor so as to define the area to be redacted. The system then displays a transparent box over the area defined by the user with a default redaction label in the center of the redacted area. The system makes a database entry indicating the username, date and time for the particular redaction. The area of the document that is to be redacted can be changed by using the cursor to click and drag the transparent box to another area of the displayed page. Likewise, the size of any redaction can be modified by holding the cursor, for example, over the a corner of the redacted area until a “resize” pointer appears (see FIG. 9). The cursor then is moved to resize the transparent box to the desired size.

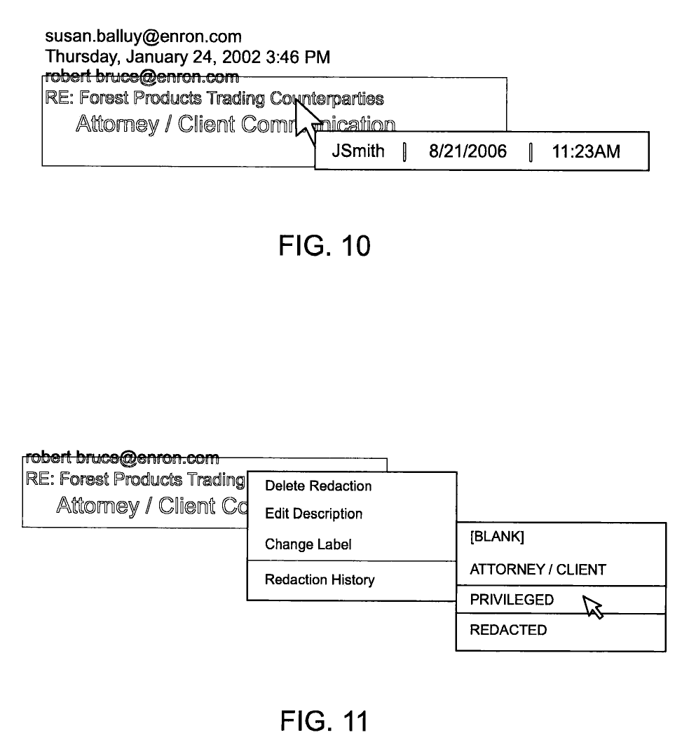

If the cursor is placed over the redacted area for a short time (e.g., a few seconds), an information box will appear to indicate the name or identification of the person who added the redaction, as well as the date and time of the added or modified redaction (see FIG. 10).

A context menu is available and offers the user options for redaction deletion, label modification and redaction history (see FIG. 11). To access the context menu, the user places the cursor over the redacted area and uses the electronic mouse to right-click. The “Delete Redaction” option is used to remove the selected redaction. Selecting the “Edit Redaction” option causes the system to display a dialog box that allows the user to add or modify a specific description of the redaction material. For example, the description might specify that the redacted material discusses an attorney-client communication with respect to particular subject matter. If the cursor is placed over the redacted area for a short time, the information box that is displayed will include the description of the redacted material, as well as the information discussed above in connection with FIG. 10. Preferably, the displayed information in the box is concatenated into a single searchable field.

As illustrated in FIG. 11, the user can specify or change a label for the redacted area by selecting the “Change Label” option. In some implementations, the text of the label for the redacted area can be selected from the following options: “Attorney/Client,” “Privileged” or “Redacted.” Other options may be available in some implementations. In any event, the selected label is displayed over the redacted area of the document. The label appearing over a redacted area also can be changed, for example, by using the drop-down menu 58 (FIG. 7) and selecting the desired label. The drop-down menu 58 includes an option “Edit Labels,” which allows the user to rename labels, as well as add new labels or delete existing labels in the list of available options. If the user clicks the “Edit Labels” option, the system displays a dialog window from which the foregoing actions can be performed (see FIG. 13). Selecting the “Default” button 62 makes the selected label the default for all new redactions. The “[BLANK]” label is a system label that will not display any text within the redacted area. Changes to the name of a label are propagated throughout the system and are reflected on all applicable documents.

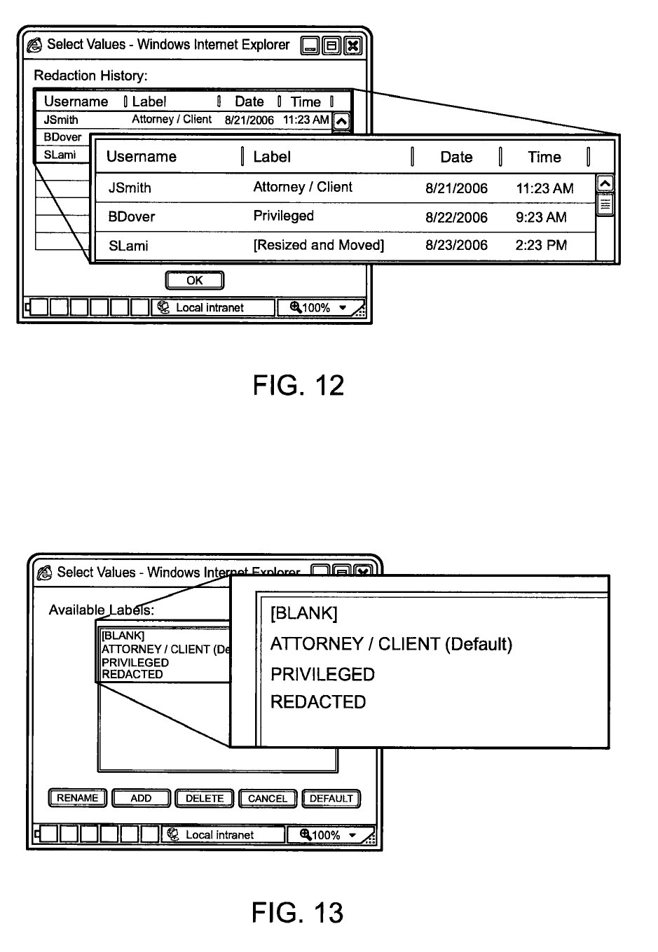

The context menu of FIG. 11 also allows a user to select a “Redaction History” option, which causes the system to display a dialog box listing all previous changes to the selected redaction. An example of such a dialog box is illustrated in FIG. 12.

Redactions added to a document are not finalized by the system until the user clicks the “Exit” button 64 (see FIG. 7). Upon selection of the “Exit” button 64, the system returns the screen to the redaction mode (see, e.g., FIG. 3) and sends the current redactions in the document to a processing queue to be “burned in.” During the “burn in” process, the overlaid redactions are embedded into an image version of the document, which strips away all text within the original pdf image of the document and creates a new non-searchable black and white redacted pdf image. Preferably, the redacted text remains in a document database so that even the redacted text can be returned in response to a user query. If a user selects a document while the system is still processing redactions made to the same document, the system displays an indication to the user that redaction finalization is in progress. When the finalized document becomes available, it automatically is displayed.

Redactions also can be saved by clicking either the “Save” button 66 or the “Save & Next” button 68 in the review panel 32. Those buttons also can be used to edit metadata fields.

The system incorporates a backend process that monitors the state of redacted documents and automatically finalizes them, for example, when the user closes a window, but before the “Exit” button 64 is selected. Among the items of information that the system tracks within the backend database are the following: redacted (yes/no/orphaned), redaction set (multi-value field), finalized (multi-value field), redaction description, and redaction history (multi-value field).

Redaction capabilities are available on a per-user basis. However, additional granularity can be made available for specific features. For example, sub-levels of access can be defined to allow for read-only, creation, modification, and administrator capabilities. The read-only access capability can be used, for example, to allow specified users or classes of users to view the “solid” version of redacted documents only. This may be useful in situations where a user is allowed to view documents through the web-based system, but is to have restricted access. Other types of access restrictions allow specified users to add or modify only redactions that they created. Although such users are permitted to view other redactions, they are permitted to edit only those they created.

Various implementations include additional features.

For example, in some implementations, the system allows a user to apply the same redactions to duplicate documents without having to separately enter the redactions for each copy of the document. Likewise, in some implementations, the system allows a user to apply the same redactions to multiple documents without having to separately enter the redactions for each document. For example, such a feature can be useful when applying redactions to spreadsheets or other formatted documents that need to have the same redactions applied from page to page or document to document.

In some implementations, the user can reverse redactions to multiple documents at the same time.

In some implementations, the system allows an administrator to specify database fields that can be redacted along with the pdf image. The system provides the administrator with a list of fields that users have rights to in the repository. The administrator can delete fields from view, can add fields that previously were deleted, and can update the details of a field throughout the system. The administrator also can select whether a field can be sorted, redacted or edited.

If a portion of a document being redacted also exists as metadata, it may be desirable to redact the same information from the database that is to be produced with the redacted document. The system provides the ability for a user to indicate which metadata fields are to be redacted and what label will appear in the produced document.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

The web-based system can be implemented to include one or more servers coupled to a database storing the documents. The servers are configured to perform the system functions discussed above. The user can access the system using, for example, a laptop or desktop personal computer that is coupled to the server(s) via the Internet and has an associated printer for printing the documents.

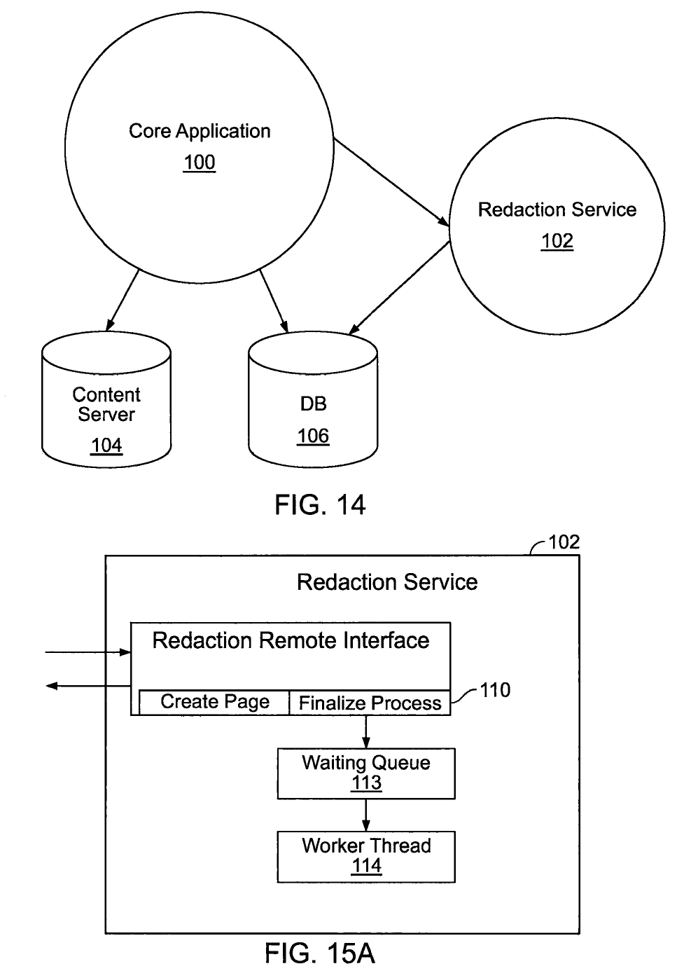

FIG. 14 illustrates an example of the architecture for the web-based data analysis and document review system. The core application 100 can be implemented, for example, as a Java engine operating behind the user interface. The redaction service 102 can be separate from the core application 100 and can be implemented, for example, as a Java interpreter action component. The core application 100 is coupled to a content engine 104. Both the core application 100 and the redaction service 102 are coupled to a SQL database 106.

When a user initiates redaction of a document, the system creates a unique job identifier for that redaction. The user uses the graphical user interface as described above to specify or modify the area of the document to be redacted. The redaction service 102 records the positions of the redacted areas of the document in the database 106 according to a document grid (e.g., by specifying the X-Y coordinates of the document area to be redacted). During the redaction finalization process, the positions stored in the database are used to “burn” redaction boxes (i.e., to overlay components of a multi-layered document) associated with the various documents to be redacted. This technique facilitates making modifications to the redactions because it is not necessary to re-process the entire document with the new redactions.

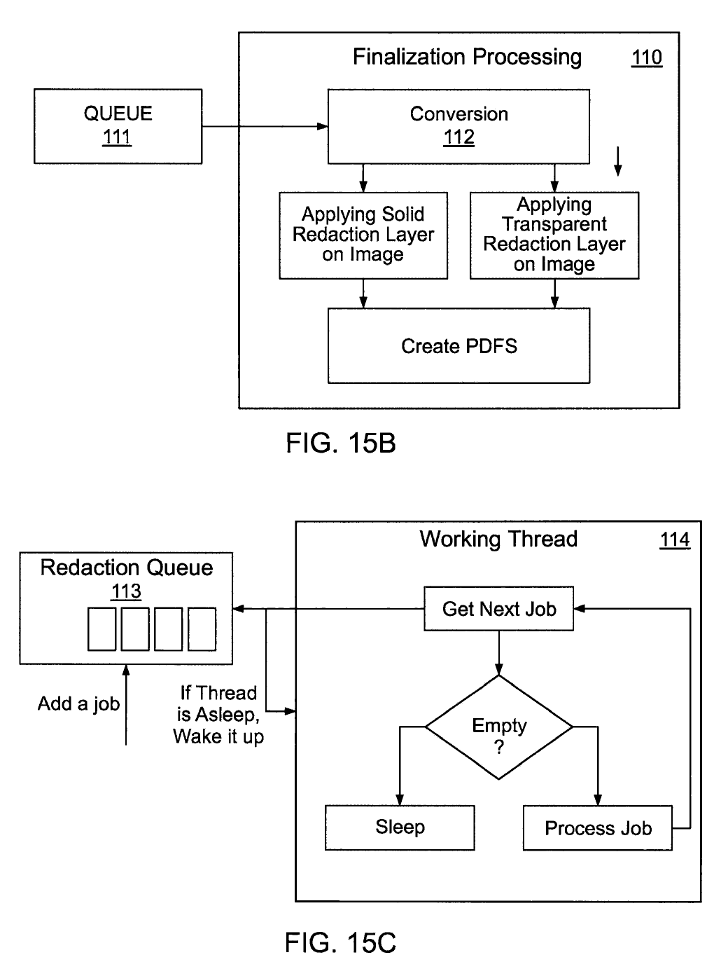

FIGS. 15A, 15B and 15C illustrate additional details of the redaction service 102, including a finalization processing engine 110, a waiting queue 113 and a worker thread 114. In particular, FIG. 15B illustrates additional details of the finalization processing which takes place when a redaction request is received from a queue 111. A conversion engine 112 converts an editable pdf version of the document to an uneditable jpg version. Depending on the type of redaction specified by the user, either a solid or transparent redaction layer is applied over the area of the image to be redacted. A pdf version of the redacted document is created. FIG. 15C illustrates further details of operation of the waiting queue 113 and worker thread 114.

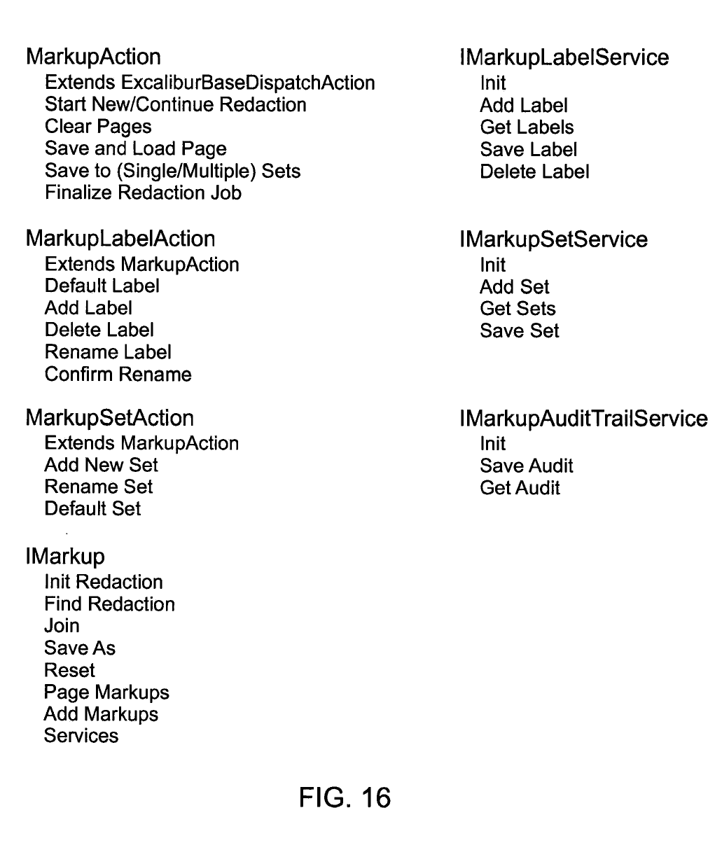

The illustrated architecture employs multi-part document controls to build multiple redaction sets through a looping process. Available commands include: MarkupAction, MarkupLabelAction and MarkupSetAction. Available controls for tagging documents include: IMarkup, ImarkupSetService, IMarkupLabelService and ImarkupAuditTrailService. FIG. 16 is a list of available controls for a particular implementation.

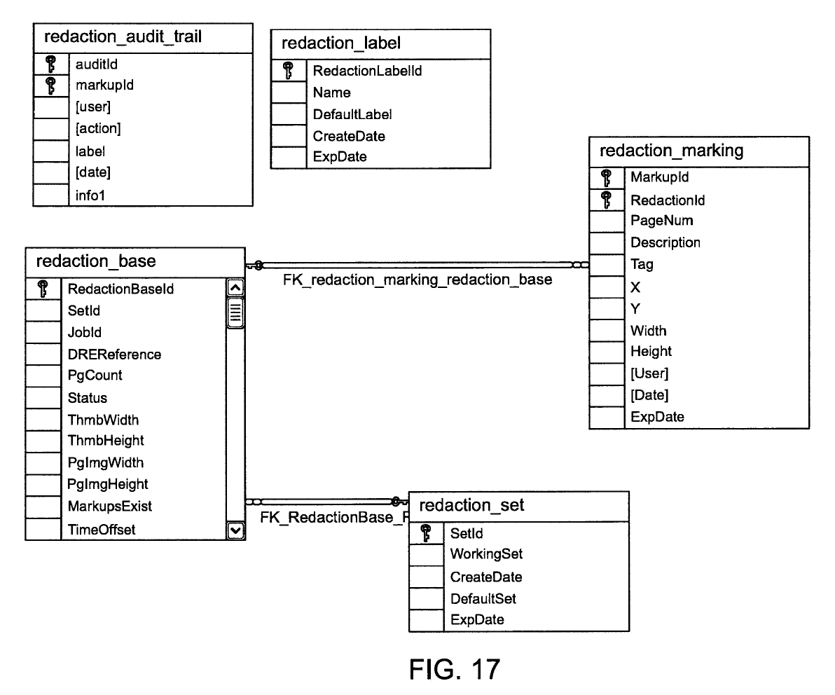

The database 106 (FIG. 13) stores various fields. Examples of fields stored according to a particular implementation are illustrated in FIG. 17.

The system can incorporate multiple redaction servers that are separate from the master service in a distributed architecture. By providing multiple iterations of the redaction service on a common front end, the system can facilitate scalability.

Other implementations are within the scope of the claims.

What is claimed is:

1. A method in a web-based data analysis and document review system, the method comprising:
providing a graphical user interface that allows a user to make and save redactions within a selected document set, apply the redactions to other document sets, clear redactions on a particular page of a document, and clear all redactions within the document.

2. The method of claim 1 including making redactions to multiple document sets substantially simultaneously.

3. The method of claim 2 including displaying a dialog box to allow the user to select the document sets to which the redactions are to be applied.

4. The method of claim 1 including saving multiple different redacted versions of a document.

5. The method of claim 1 including, when a cursor is placed over a redacted area of a document, displaying an information box that indicates the identification of a person who added the redaction to the document, and at least one of the date and time of the redaction.

6. The method of claim 1 including displaying a label over a redacted area of a document, wherein contents of the label are specified by entering information through the graphical user interface.

7. The method of claim 1 including displaying a dialog box listing a history of a selected redaction.

8. The method of claim 1 including providing redaction capabilities on a per-user basis, wherein different users or classes of users are given different redaction capabilities.

9. The method of claim 1 including recording a position of a redacted area of the document by specifying coordinates of the document area to be redacted.

10. A web-based data analysis and document review system comprising:
a user terminal; and
one or more servers coupled to the user terminal to provide a graphical user interface that allows a user to make and save redactions within a selected document set, apply the redactions to other document sets, clear redactions on a particular page of a document, and clear all redactions within the document.

11. The system of claim 10 operable to allow the user to make redactions to multiple document sets substantially simultaneously.

12. The system claim 11 wherein the one or more servers are operable to display a dialog box to allow the user to select the document sets to which the redactions are to be applied.

13. The system of claim 10 operable to save multiple different redacted versions of a document.

14. The system of claim 10 arranged so that when a cursor is placed over a redacted area of a document appearing on the user terminal, the system displays an information box that indicates the identification of a person who added the redaction to the document, and at least one of the date and time of the redaction.

15. The system of claim 10 operable to display a label over a redacted area of a document, wherein contents of the label are based on information entered through the graphical user interface.

16. The system of claim 10 operable to display a dialog box listing a history of a selected redaction.

17. The system of claim 10 arranged to provide redaction capabilities on a per-user basis, wherein different users or classes of users are given different redaction capabilities.

18. The system of claim 10 operable to record a position of a redacted area of the document by specifying coordinates of the document area to be redacted.

19. An article comprising a machine-readable medium that stores machine-executable instructions for causing a machine in a web-based data analysis and document review system to:
provide a graphical user interface that allows a user to make and save redactions within a selected document set, apply the redactions to other document sets, clear redactions on a particular page of a document, and clear all redactions within the document.

20. The article of claim 19 including instructions to cause the machine to make redactions to multiple document sets substantially simultaneously in response to a user request.

21. The article of claim 20 including instructions to cause the machine to display a dialog box to allow the user to select the document sets to which the redactions are to be applied.

22. The article of claim 19 including instructions to cause the machine to save multiple different redacted versions of a document.

23. The article of claim 19 including instructions to cause the machine to display an information box when a cursor is placed over a redacted area of a document, wherein the information box indicates the identification of a person who added the redaction to the document, and at least one of the date and time of the redaction.

24. The article of claim 19 including instructions to cause the machine to display a label over a redacted area of a document, wherein contents of the label are specified by entering information through the graphical user interface.

25. The article of claim 19 including instructions to cause the machine to display a dialog box listing a history of a selected redaction.

26. The article of claim 19 including instructions to cause the machine to provide redaction capabilities on a per-user basis, wherein different users or classes of users are given different redaction capabilities.

27. The article of claim 19 including instructions to cause the machine to record a position of a redacted area of the document by specifying coordinates of the document area to be redacted.
